(19) United States
(12) Patent Application Publication
(10) Pub. No.: US 2016/0179326 A1
(43) Pub. Date: Jun. 23, 2016

(54) MEDICAL IMAGING APPARATUS AND METHOD FOR MANAGING TOUCH INPUTS IN A TOUCH BASED USER INTERFACE

(71) Applicant: General Electric Company, Schenectady, NY (US)

(72) Inventor: Anil Kumar Thimmanahalli Aswathanarayana, Bangalore (IN)

(21) Appl. No.: 14/712,222

(22) Filed: May 14, 2015

(30) Foreign Application Priority Data
Dec. 23, 2014 (IN) 6499/CHE/2014

(51) Int. Cl. G06F 3/0488; G06F 3/0484

(52) U.S. Cl. CPC G06F 3/0488; G06F 3/04842; G06F 3/04845; G06F 3/04847

(57) ABSTRACT

An apparatus for managing touch inputs from a user is disclosed. The apparatus comprises a user interface configured as a touch sensitive display and capable of receiving touch inputs. The touch input processor is configured to process touch inputs associated to a function in one or more first regions of the user interface and perform operations in a second region of the user interface to execute the function.

### FIELD OF THE INVENTION

The subject matter disclosed herein relates to touch based user interface of a medical imaging apparatus. More specifically the subject matter relates to managing touch inputs from a user on the touch based user interface.

### BACKGROUND OF THE INVENTION

Nowadays touch based user interface is common in all devices used in fields varying from consumer products to healthcare related products. Mobile devices such as smart phones used by users have touch based user interface and all operations in the devices are performed based on touch inputs received from the user. Numerous healthcare devices also have touch based user interface for instance an ultrasound imaging device may have touch based user interface. The ultrasound imaging device may be a portable tablet device or a portable mobile device having an ultrasound probe. The ultrasound probe is used for capturing medical images from the patient that are presented in the user interface of the ultrasound imaging device. The user may need to do measurements in a medical image and different touch inputs can be given to perform measurements. The user may be holding the ultrasound imaging device in one hand and the probe in other hand, and thus using user's finger to perform operations on the user interface may be difficult. This is because stretching user's fingers to access different areas of the user interface is strenuous. For performing measurements different measurement elements may need to be drawn on the medical image depending on requirements. The measurement elements include line, circle, ellipse, trace, spline and any free shape. The measurement elements need to be drawn on the medical image using touch inputs using finger usually user's thumb as other fingers are used to hold the ultrasound imaging device. The area in the medical image where measurement needs to be performed may require the thumb finger to be stretched to reach. Frequent stretching of the finger cause fatigue and stretch injury. Further the ultrasound imaging device may be thick and heavy due to hardware and batteries that are embedded in the device. This makes it difficult to perform measurements on the images with the thumb.

To generate measurement elements the user may use user's finger to mark points on the medical image and draw measurement element joining these points. Moving these points and drawing the measurement element using user's finger may be difficult because the points get covered by the user's finger. As a result relocating the point to a different target pixel location in the user interface is difficult. So the user needs to frequently lift the finger to see the position of the point and then move to target location. Even though difficulty in moving points and other UI elements in the user interface is there in ultrasound imaging device similar kind of issues are also present in usual functionalities and activities in mobile phones.

Accordingly, a need exists for an improved method of managing touch inputs in a touch based user interface.

### SUMMARY OF THE INVENTION

The object of the invention is to provide an improved method and apparatus capable of managing and processing touch inputs from a user as defined in the independent claim. This is achieved by an apparatus having a user interface and a touch input processor configured to process touch inputs in a region of the user interface and perform operations corresponding to the touch inputs in another region of the user interface.

One advantage with the disclosed system is that it provides an improved way of accessing or editing UI elements in a touch based user interface without actually touching the UI elements. In a healthcare field, and particularly ultrasound imaging multiple measurement elements for performing measurements on an ultrasound image can be generated without actually providing touch inputs on the ultrasound image but by providing touch inputs regions around the actual region of interest in the image. So any gesture (touch gestures) provided anywhere in the UI around the area of interest results in drawing a measurement element in the area of interest.

In an embodiment an apparatus for managing touch inputs from a user is disclosed. The apparatus comprises a user interface configured as a touch sensitive display and capable of receiving touch inputs. The touch input processor is configured to process touch inputs associated to a function in one or more first regions of the user interface and perform operations in a second region of the user interface to execute the function.

In another embodiment a method of processing touch inputs from a user is disclosed. The method includes receiving touch inputs associated with a function at a user interface configured as a touch sensitive display; processing the touch inputs in one or more first regions of the user interface; and performing operations in a second region of the user interface to execute the function.

A more complete understanding of the present invention, as well as further features and advantages thereof, will be obtained by reference to the following detailed description and drawings.

### BRIEF DESCRIPTION OF THE DRAWINGS

FIG. 1 illustrates an apparatus for managing and processing touch inputs from a user according to an embodiment;

FIG. 1 illustrates a handheld ultrasound imaging system that directs ultrasound energy pulses into an object, typically a human body in accordance with an embodiment;

FIG. 2 is a schematic illustration of a handheld ultrasound imaging system that directs ultrasound energy pulses into an object according to an embodiment;

FIG. 3 is a schematic illustration of a handheld medical imaging apparatus in accordance with an embodiment;

FIGS. 4A and 4B are schematic illustrations of a handheld medical imaging apparatus (such as the ultrasound imaging apparatus) presenting a medical image according to an embodiment;

FIG. 5 is a schematic illustration of a handheld medical imaging apparatus presenting the medical image wherein measurement is performed using another measurement element according to an embodiment;

FIG. 6 is a schematic illustration of a handheld medical imaging apparatus presenting the medical image wherein a point in the measurement element is editable according to an embodiment;

FIG. 7 is a schematic illustration of a handheld medical imaging apparatus presenting the medical image wherein a point in another measurement element is editable according to another embodiment;

FIG. 8 is a schematic illustration of a handheld medical imaging apparatus presenting the medical image wherein orientation of a measurement element is changed according to an embodiment;

FIG. 9 is a schematic illustration of a handheld medical imaging apparatus presenting a medical image wherein a measurement element is generated according to another embodiment;

FIG. 10 illustrates a flow diagram of a method for managing and processing touch inputs from a user according to an embodiment; and

FIG. 11 illustrates a flow diagram of a method for generating the one or more measurement elements according to an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical and other changes may be made without departing from the scope of the embodiments. The following detailed description is, therefore, not to be taken as limiting the scope of the invention.

As discussed in detail below, embodiments of an apparatus for managing touch inputs from a user is disclosed. The apparatus comprises a user interface configured as a touch sensitive display and capable of receiving touch inputs. The touch input processor is configured to process touch inputs associated to a function in one or more first regions of the user interface and perform operations in a second region of the user interface to execute the function.

FIG. 1 illustrates an apparatus 100 for managing and processing touch inputs from a user according to an embodiment. The apparatus 100 includes a user interface 102 configured as a touch sensitive display. The user may provide touch inputs on the user interface 102 for performing various activities. The activities may include but not limited to, accessing a user interface (UI) element, accessing menu items, sliding operations, using multiple applications, reading documents and so on. The apparatus 100 may be for instance a mobile device, a smart phone, a tablet device and a medical imaging device. The touch inputs may be given as user's gestures such as finger movements on the user interface 102.

The touch inputs are received at one or more first regions such as a first region 104 in the user interface 102. The first region may be a portion of real estate or display area in the user interface 102. These touch inputs may be associated to a function that needs to be performed. The function here may include accessing a user interface (UI) element, accessing menu items, sliding operations, using multiple applications, reading documents and so on. A touch input processor 106 processes the touch inputs to perform operations in one or more second regions such as a second region 108. The second region 108 is a portion of the real estate or display area of the user interface 102. The second region 108 and the first region 104 are at different locations in the user interface 102 as illustrated in FIG. 1. In an embodiment the first region may overlap with the second region. The second region 108 and the first region 104 are shown using imaginary lines for the convenience of representation in FIG. 1. The touch input processor 106 performs operations in the second region to execute the function. Considering an example a user interface element present in the second region 108 may need to be accessed. The user may provide touch inputs such as a long press using user's finger 110 in the first region 104 then the user interface element is selected. Thereafter a tapping action by the user's finger 110 may be provided as the touch input which results in selection of the user interface element. If the user interface element is associated with an application then the application may be launched and accessible to the user.

Hereinafter the apparatus for managing and processing touch inputs from a user is described in the context of medical imaging and more particularly ultrasound imaging according to an embodiment, however it may be envisioned that the apparatus and method can be applicable to any other field such as but not limited to accessing UI elements in a mobile device, a smart phone and so forth without limiting from the scope of the disclosure.

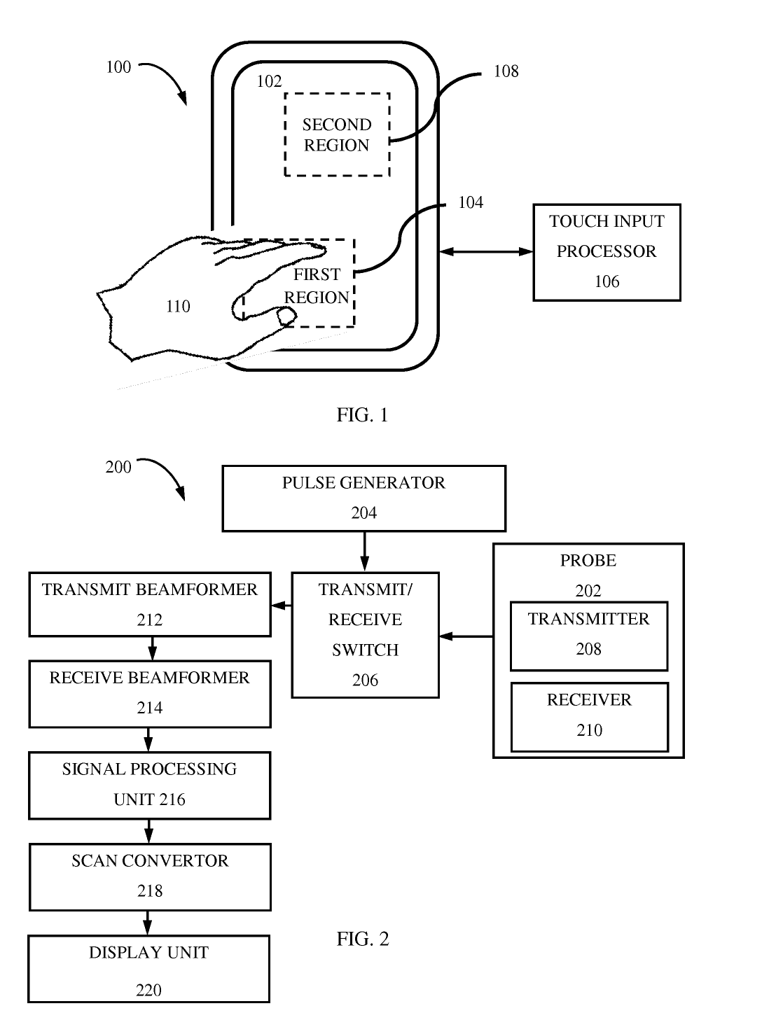

A touch based user interface may be applicable in other areas for instance healthcare domain. The touch based user interface may be also present for a medical imaging device such as an ultrasound imaging system. FIG. 2 shows a handheld ultrasound imaging system 200 that directs ultrasound energy pulses into an object, typically a human body, and creates an image of the body based upon the ultrasound energy reflected from the tissue and structures of the body. The ultrasound imaging system 200 may include a portable or handheld ultrasound imaging system or apparatus.

The ultrasound imaging system 200 comprises a probe 202 (i.e. an image acquisition unit) that includes a transducer array having a plurality of transducer elements. The probe 202 and the ultrasound imaging system 200 may be physically connected, such as through a cable, or they may be in communication through a wireless technique. The transducer array can be one-dimensional (1-D) or two-dimensional (2-D). A 1-D transducer array comprises a plurality of transducer elements arranged in a single dimension and a 2-D transducer array comprises a plurality of transducer elements arranged across two dimensions namely azimuthal and elevation. The number of transducer elements and the dimensions of transducer elements may be the same in the azimuthal and elevation directions or different. Further, each transducer element can be configured to function as a transmitter 208 or a receiver 210. Alternatively, each transducer element can be configured to act both as a transmitter 208 and a receiver 210.

The ultrasound imaging system 200 further comprises a pulse generator 204 and a transmit/receive switch 206. The pulse generator 204 is configured for generating and supplying excitation signals to the transmitter 208 and the receiver 210. The transmitter 208 is configured for transmitting ultrasound beams, along a plurality of transmit scan lines, in response to the excitation signals. The term “transmit scan lines” refers to spatial directions on which transmit beams are positioned at some time during an imaging operation. The receiver 210 is configured for receiving echoes of the transmitted ultrasound beams. The transmit/receive switch 206 is configured for switching transmitting and receiving operations of the probe 202.

The ultrasound imaging system 200 further comprises a transmit beamformer 212 and a receive beamformer 214. The transmit beamformer 212 is coupled through the transmit/receive (T/R) switch 206 to the probe 202. The transmit beamformer 212 receives pulse sequences from the pulse generator 204. The probe 202, energized by the transmit beamformer 212, transmits ultrasound energy into a region of interest (ROI) in a patient's body. As is known in the art, by appropriately delaying the waveforms applied to the transmitter 208 by the transmit beamformer 212, a focused ultrasound beam may be transmitted.

The probe 202 is also coupled, through the T/R switch 206, to the receive beamformer 214. The receiver 210 receives ultrasound energy from a given point within the patient's body at different times. The receiver 210 converts the received ultrasound energy to transducer signals which may be amplified, individually delayed and then accumulated by the receive beamformer 214 to provide a receive signal that represents the received ultrasound levels along a desired receive line (“transmit scan line” or “beam”). The receive signals are image data that can be processed to obtain images i.e. ultrasound images of the region of interest in the patient's body. The receive beamformer 214 may be a digital beamformer including an analog-to-digital converter for converting the transducer signals to digital values. As known in the art, the delays applied to the transducer signals may be varied during reception of ultrasound energy to effect dynamic focusing. The process of transmission and reception is repeated for multiple transmit scan lines to create an image frame for generating an image of the region of interest in the patient's body.

In an alternative system configuration, different transducer elements are employed for transmitting and receiving. In that configuration, the T/R switch 206 is not included, and the transmit beamformer 212 and the receive beamformer 214 are connected directly to the respective transmit or receive transducer elements.

The receive signals from the receive beamformer 214 are applied to a signal processing unit 216, which processes the receive signals for enhancing the image quality and may include routines such as detection, filtering, persistence and harmonic processing. The output of the signal processing unit 216 is supplied to a scan converter 218. The scan converter 218 creates a data slice from a single scan plane. The data slice is stored in a slice memory and then is passed to a display unit 220, which processes the scan converted image data so as to display an image of the region of interest in the patient's body.

In one embodiment, high resolution is obtained at each image point by coherently combining the receive signals thereby synthesizing a large aperture focused at the point. Accordingly, the ultrasound imaging system 200 acquires and stores coherent samples of receive signals associated with each receive beam and performs interpolations (weighted summations, or otherwise), and/or extrapolations and/or other computations with respect to stored coherent samples associated with distinct receive beams to synthesize new coherent samples on synthetic scan lines that are spatially distinct from the receive scan lines and/or spatially distinct from the transmit scan lines and/or both. The synthesis or combination function may be a simple summation or a weighted summation operation, but other functions may as well be used. The synthesis function includes linear or nonlinear functions and functions with real or complex, spatially invariant or variant component beam weighting coefficients. The ultrasound imaging system 200 then in one embodiment detects both acquired and synthetic coherent samples, performs a scan conversion, and displays or records the resulting ultrasound image.

Ultrasound data is typically acquired in image frames, each image frame representing a sweep of an ultrasound beam emanating from the face of the transducer array. A 1-D transducer array produces 2-D rectangular or pie-shaped sweeps, each sweep being represented by a series of data points. Each of the data points are, in effect, a value representing the intensity of an ultrasound reflection at a certain depth along a given transmit scan line. On the other hand, the 2-D transducer array allows beam steering in two dimensions as well as focus in the depth direction. This eliminates the need to physically move the probe 202 to translate focus for the capture of a volume of ultrasound data to be used to render 3-D images.

One method to generate real-time 3-D scan data sets is to perform multiple sweeps wherein each sweep is oriented in a different scan plane. The transmit scan lines of every sweep are typically arrayed across the probe's 202 “lateral” dimension. The planes of the successive sweeps in an image frame are rotated with respect to each other, e.g. displaced in the “elevation” direction, which is typically orthogonal to the lateral dimension. Alternatively, successive sweeps may be rotated about a centerline of the lateral dimension. In general, each scan frame comprises plurality of transmit scan lines allowing the interrogation of a 3-D scan data set representing a scan volume of some pre-determined shape, such as a cube, a sector, frustum, or cylinder.

In one exemplary embodiment, each scan frame represents a scan volume in the shape of a sector. Therefore the scan volume comprises multiple sectors. Each sector comprises plurality of beam positions, which may be divided into sub sectors. Each sub sector may comprise equal number of beam positions. However, it is not necessary for the sub sectors to comprise equal number of beam positions. Further, each sub sector comprises at least one set of beam positions and each beam position in a set of beam positions is numbered in sequence. Therefore, each sector comprises multiple sets of beam positions indexed sequentially on a predetermined rotation.

Plurality of transmit beam sets are generated from each sector. Further, each transmit beam set comprises one or more simultaneous transmit beams depending on the capabilities of the ultrasound imaging system 200. The term “simultaneous transmit beams” refers to transmit beams that are part of the same transmit event and that are in flight in overlapping time periods. Simultaneous transmit beams do not have to begin precisely at the same instant or to terminate precisely at the same instant. Similarly, simultaneous receive beams are receive beams that are acquired from the same transmit event, whether or not they start or stop at precisely the same instant.

The transmit beams in each transmit beam set are separated by the plurality of transmit scan lines wherein each transmit scan line is associated with a single beam position. Thus, the multiple transmit beams are arranged in space separated such that they do not have significant interference effects.

The transmit beamformer 212 can be configured for generating each transmit beam set from beam positions having the same index value. Thus, beam positions with matching index value, in each sub sector, can be used for generating multiple simultaneous transmit beams that form a single transmit beam set. In one embodiment, at least two consecutive transmit beam sets are generated from beam positions not indexed sequentially. In an alternative embodiment, at least a first transmit beam set and a last transmit beam set, in a sector, are not generated from neighboring beam positions.

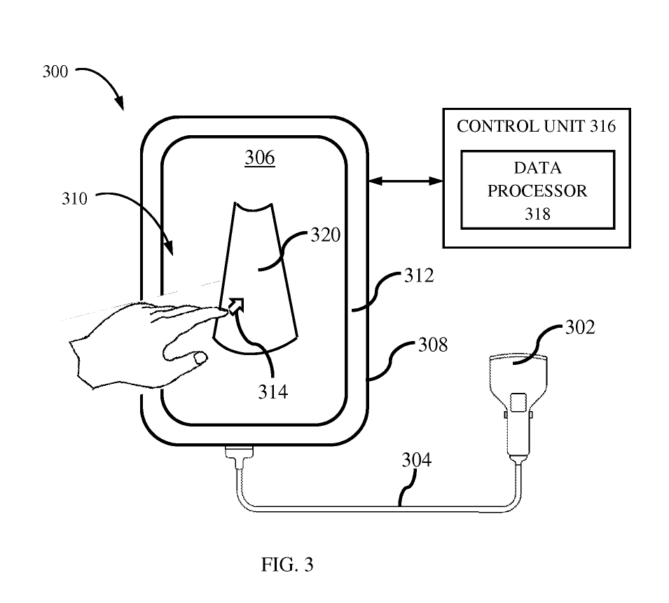

FIG. 3 is a schematic illustration of a handheld medical imaging apparatus 300 in accordance with an embodiment. The handheld medical imaging apparatus 300 may be an ultrasound imaging apparatus. FIG. 3 is described hereinafter as the handheld ultrasound imaging apparatus 300 however the functions and components of this apparatus may be applicable to other handheld medical imaging apparatuses as well without departing from scope of this disclosure. The handheld ultrasound imaging apparatus 300 includes an ultrasound probe 302 communicably connected at a port (not shown in FIG. 3) using a connecting cord 304. However it may be envisioned that an ultrasound probe may be connected to the handheld ultrasound imaging apparatus 300 using a wireless connection. The ultrasound probe 302 is used to send ultrasonic signals to a portion of the patient's body to acquire diagnostic ultrasound images. The diagnostic ultrasound images are displayed in a display 306. The diagnostic ultrasound images (i.e. image frames) are part of a live image video. The display 306 is held by a housing 308. A user interface 310 may be provided in one or more of a display and a housing of a handheld imaging apparatus. The user interface 310 may be a touch based interface. A user can hold the handheld ultrasound imaging apparatus 300 with a hand 312 and place a thumb on the user interface 310 to control a pointer 314 (i.e. a cursor) for providing user input at points on the display 306. The pointer 314 may be visible only when the thumb is positioned on the user interface 310. The thumb can be moved on the user interface 310 to accurately identify a point where user inputs need to be given. A control unit 316 including a data processor 318 may be configured to detect movements or gestures of the thumb on the user interface 310. Consequently the control unit 316 identifies the point and performs one or more activities at the point. An activity performed may be for instance selection of the point based on the user input. Here the user input is for example the gesture performed using the thumb for selecting a point. The gesture may be a single click or a double click on the user input interface 210. However it may be envisioned that other kinds of gestures such as a long click, a multi-touch, a flick and the like may be used for selecting the point on the display 306. The activity resulting from the gesture as discussed earlier is selection of the point. Considering an example the user can move the thumb on the user input interface 310 to select or indicate a point on an ultrasound image 320. The pointer 314 can assist the user in indicating and selection of the point with reduced human errors. The ultrasound image 320 is an image frame of the live image video that is freezed by the user. The user may provide some gestures in the user interface 310 for freezing the image frame. Further the image frame can be un-freezed in response to providing gestures in the user interface 310.

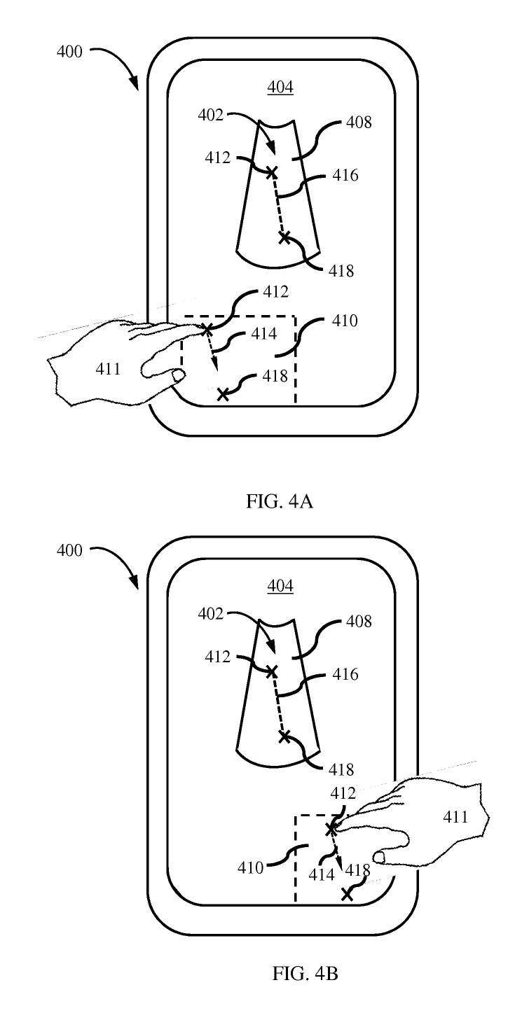

Now moving on to FIGS. 4A and 4B illustrating a handheld medical imaging apparatus 400 (such as the ultrasound imaging apparatus) presenting a medical image 402 according to an embodiment. The medical image 402 is presented in a user interface 404. Measurements need to be performed in the medical image 402 for the user. The measurements that may be performed include but are not limited to femur length (FL), diameter (BPD), head circumference (HC), and abdominal circumference (AC). As illustrated in FIG. 4 a line 416 may be generated and overlaid on the medical image 402 to perform measurement. The line 416 is a measurement element. In an embodiment the user can configure the medical imaging apparatus 400 in a measurement mode. The measurement mode may be configured in response to selecting appropriate UI element in the medical imaging apparatus 400. In another embodiment the measurement mode may be configured in response to a user's gesture. The line 416 is generated in a second region 408 overlapping with the medical image 402. The line 416 is generated in response to touch inputs in a first region 410. Each second region may have one or more first regions predefined. The first region 410 may be in different locations of a display area of the user interface 404 as shown in FIGS. 4A and 4B. In another instance the first region 410 may overlap with the second region 408. In this case touch inputs are given in a region within the medical image 402 near to or besides the line 416 for drawing the line 416 in the second region. Thus the first region 410 can be any location in the display area of the user interface 404. In an embodiment when configured in the measurement mode the user can define a second region in the medical image 402 where the measurement needs to be performed and one or more first regions around the second region or overlapping with the second region. For example the user may use a finger 411 to tap on the first region 410 so that a point 412 is created in the second region 408. In an embodiment when the finger 411 is tapped then a point is selected in the first region 410 that may correspond to the point 412. Thereafter the finger 411 is moved in a direction (shown by an arrow 414) desired for the user. Consequently a line 416 starts expanding or drawn from the point 412 in the second region 408. Once the user removes the finger 411 from the user interface 404 then a point 418 which is an end point of the line 416. The end point of the line 416 may also have a corresponding point in the first region 410. The points and line 416 if shown in the first region 410 are imaginary. The line 416 is used for performing measurement on the medical image 402.

FIG. 5 illustrates the handheld medical imaging apparatus 400 presenting the medical image 402 wherein measurement is performed using another measurement element according to an embodiment. The measurement element drawn here may be an ellipse 504 on the medical image 402. The measurement element to be used may be set by configuring the medical imaging apparatus 400. More specifically the medical imaging apparatus 400 may be configured to set the measurement element as the ellipse 504 by selecting a UI element presented in the user interface 404. As illustrated in FIG. 5 an ellipse 504 may be generated and overlaid on the medical image 402 to perform measurement. In an embodiment the user can configure the medical imaging apparatus 400 in a measurement mode. The measurement mode may be configured in response to selecting appropriate UI element in the medical imaging apparatus 400. In another embodiment the measurement mode may be configured in response to a user's gesture. The ellipse 504 is generated in the second region 408 overlapping with the medical image 402. The ellipse 504 is generated in response to touch inputs in the first region 410. Each second region may have one or more first regions predefined. In an embodiment when configured in the measurement mode the user can define a second region in the medical image 402 where the measurement needs to be performed and one or more first regions around the second region. For example the user may use the finger 411 to tap on the first region 410 so that a point 506 is created in the second region 408. Thereafter the finger 411 is moved in a direction (shown by an arrow 508) desired for the user. Consequently the ellipse 504 starts expanding or drawn from the point 506 in the second region 408. Once the user removes the finger 411 from the user interface 404 then a point 510 which is a second point of the ellipse 504. In another embodiment the ellipse 504 may have multiple points. The ellipse 504 is used for performing measurement on the medical image 402.

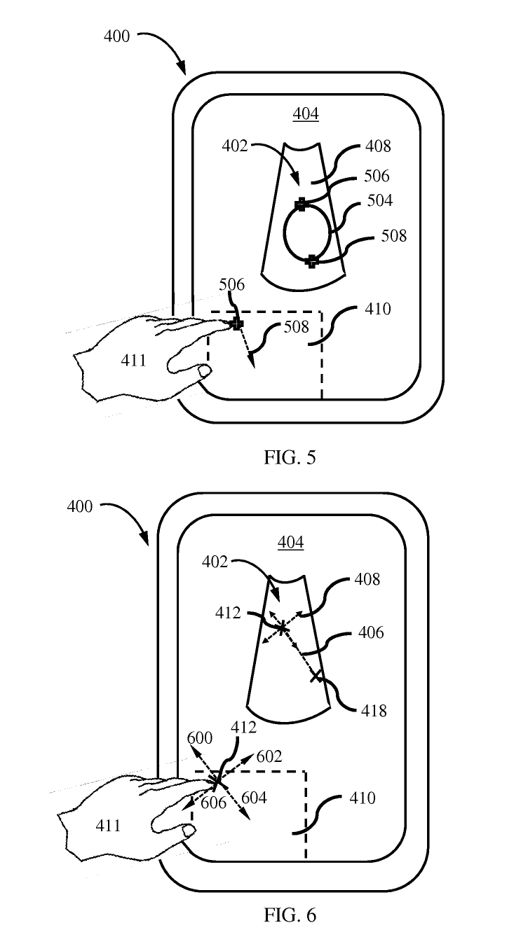

Any points in a measurement element can be edited to modify the measurement element. FIG. 6 illustrates the handheld medical imaging apparatus 400 presenting the medical image 402 wherein a point in the measurement element is editable according to an embodiment. The point in the measurement element may be edited based on touch inputs such as gestures received from the user. The touch inputs may be provided in the first region 410 and the operations are performed in the second region 408. In an embodiment the gesture may be but not limited to a tapping using user's finger 411 and a long press of user's finger 411. While tapping or long press the user's finger 411 may select a point in the first region 410 that corresponds to the point 412 in the second region 408. In response to the gesture the point 412 is converted into an editable form. In another embodiment the point 412 may be converted into an editable form based on accessing any other UI element or through a workflow or any other manner. The user can use the finger 411 to move the point 412 in different directions shown by arrows 600, 602, 604 and 606. However it may be envisioned that the point 412 can be moved in other directions other than the directions represented by the arrows 600, 602, 604 and 606. More specifically the user's finger 411 can be used to move the point in the first region as a result the point 412 moves in the second region 408. When the point 412 is edited then the measurement element i.e. the line 406 is also changed. The changes in the line 406 may be for instance change in orientation, change in length and change in end point. Thus the end point 418 may be moved so that the line 406 also changes.

In another embodiment the user may perform some other gestures such as swiping action, triple taping and so on, in the first region 410 for deleting the point 412 in the second region 408. The line 406 may have a different first point or starting point or the line 406 may be deleted. In another instance the point 418 i.e. the end point of the line 406 then becomes the starting point. Thereafter a line may be drawn with the starting point 418 at the second region 408 based on the gestures given in the first region 410. The point 418 may be deleted using the same gestures as used for deleting the point 412 as explained earlier.

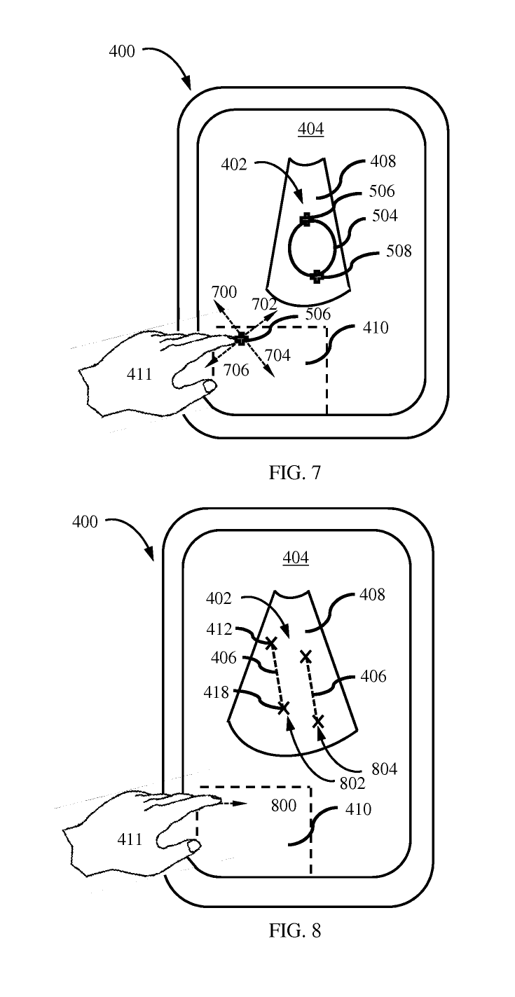

FIG. 7 illustrates the handheld medical imaging apparatus 400 representing the medical image 402 wherein a point in another measurement element is editable according to another embodiment. The measurement element shown here is an ellipse. The point in the measurement element may be edited based on touch inputs such as gestures received from the user. The touch inputs may be provided in the first region 410 and the operations are performed in the second region 408. In an embodiment the gesture may be but not limited to a tapping using user's finger 411 and a long press of user's finger 411. While tapping or long press the user's finger 411 may select a point in the first region 410 that corresponds to the point 506 in the second region 408. In response to the gesture the point 506 is converted into an editable form. In another embodiment the point 506 may be converted into an editable form based on accessing any other UI element or through a workflow or any other manner. The user can use the finger 411 to move the point 506 in different directions shown by arrows 700, 702, 704 and 706. However it may be envisioned that the point 506 can be moved in other directions other than the directions represented by the arrows 700, 702, 704 and 706. More specifically the user's finger 411 can be used to move the point in the first region as a result the point 506 moves in the second region 408. When the point 506 is edited then the measurement element i.e. the ellipse 504 is also changed. The changes in the ellipse 504 may be for instance change in orientation, change in size, change in shape and change in points in the ellipse 504. Thus the other point 508 may be moved so that the ellipse 504 also changes.

Referring now to FIG. 8 illustrating the handheld medical imaging apparatus 400 presenting the medical image 402 wherein orientation of a measurement element is changed according to an embodiment. The line 406 generated in the second region 408 overlapping with the medical image 402 can be changed or modified. For instance the user can use the finger 411 to provide gestures such as a long press or double tapping on the user interface 404. The gestures may be provided in the first region 410 and the line 406 is configured in an editable form. In another instance the line 406 may be configured in the editable form in response to accessing any other UI element or through a workflow or any other manner without limiting from the scope of the disclosure. The user then moves the finger 411 in a direction shown by an arrow 800 thereby moving the line 406 in the second region 408 in a direction corresponding to the direction of the arrow 800. As illustrated in FIG. 8 the line 406 moves from a position 802 to another position 804. This change in the orientation of the measurement element is performed to do measurements in different location of the medical image 402.

Similarly the ellipse 504 generated on the medical image 402 as shown in FIG. 5 can be also modified by changing its position. The position of the ellipse 504 can be changed from one position to another on the medical image 402.

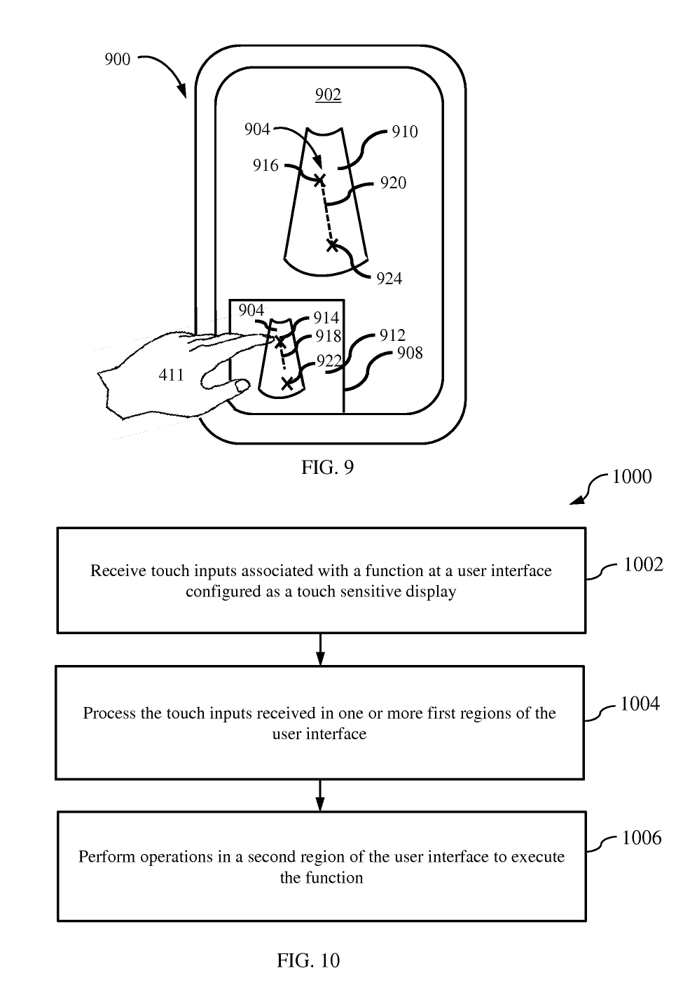

FIG. 9 illustrates a handheld medical imaging apparatus 900 presenting a medical image wherein a measurement element is generated according to another embodiment. The handheld medical imaging apparatus 900 has a user interface 902 for presenting a medical image 904. A measurement element such as a line is generated in the medical image 904 for performing measurements. The handheld medical imaging apparatus 900 provides a window 908 that presents a preview of the medical image 904. The medical image 904 shown in the window 908 is a miniature of the medical image 904 presented in the user interface 902. The medical image 904 may be presented in a second region 910 of the user interface 902. Further the medical image 904 shown in the window 908 is at a first region 912 of the user interface 902.

The user uses the finger to draw the measurement element 918 in the first region 912 i.e. the window 908. Consequently the measurement element 920 is also drawn in the medical image 904 in the second region 910. The measurement element 918 in the first region 912 is a miniature of the measurement element 920 drawn in the second region 910. For generating the measurement element 918 a point 914 is created based on a gesture made by the user's finger in the first region 912. Accordingly a point 916 corresponding to the point 914 is created in the medical image 904 in the second region 910. Then the user's finger is traced from the point 914 thereby a line 918 is generated as shown in the window 908. Simultaneously a line 920 is also generated in the second region 910 overlaying the medical image 904. The line 918 is completed in the window 908 upon ending with a point 922. At the same time the line 920 may be also drawn in the second region 910 with an end point 924. This enables the user to draw the measurement elements accurately for performing measuring on the medical image. Otherwise points of a medical image (i.e. end points of a line) may be hidden below the user's finger and thus may be inaccurate leading to measurement errors in the medical image. Here as the window 908 enables the user to draw a measurement element in the medical image 904 i.e. in a virtual image which can be replicated in the medical image 904 presented in the second region 910 the user can accurately determine the end points and generate the measurement element.

FIG. 10 illustrates a flow diagram of a method 1000 for managing and processing touch inputs from a user according to an embodiment. An apparatus includes a user interface configured as a touch sensitive display for receiving user touch inputs at block 1002. For instance the user interface may be of a handheld medical imaging apparatus that presents a medical image. The touch inputs are received in one or more first regions of the user interface. The touch inputs may be for instance gestures provided using user's finger on the user interface. The touch inputs are for performing various activities. The touch inputs may be associated with a function. The function may be performing measurement on a medical image. The touch inputs received in the one or more first regions are processed at block 1004. Thereafter at block 1006, operations are performed in a second region of the user interface to execute the function. The operations may be for instance generating one or more measurement elements for measuring in the medical image. The measurement elements include a line, a circle, an ellipse, spline, trace and any shape. Measurements need to be performed in the medical image for the user. The measurements that may be performed when the medical image is an ultrasound image include but are not limited to f femur length (FL), bi-parietal diameter (BPD), head circumference (HC), and abdominal circumference (AC).

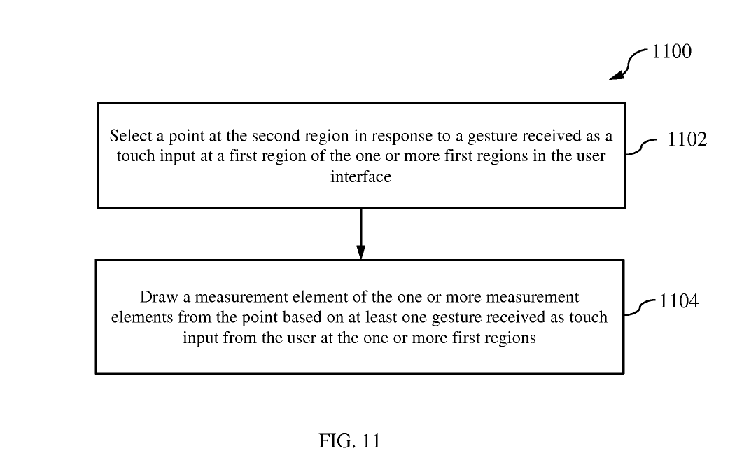

FIG. 11 illustrates a flow diagram of a method 1100 for generating the one or more measurement elements according to an embodiment. The method 1100 involves selecting a point at second region in the user interface in response to a gesture received as a touch input at a first region of the one or more first regions at block 1102. The measurement element of the one or more measurement elements is drawn from the point based on one or more gestures received as a touch input from the user at the one or more first regions. The measurement is drawn in the second region based on a corresponding measurement element drawn in the first region or a gesture movement representing the measurement element received at the one or more first regions. A measurement mode is also set in response to a gesture performed at the one or more first regions of the user interface.

Further the measurement element can be edited or modified (for example relocated or re-positioned) based on one of one or more gestures and an input performed at the one or more first regions of the user interface. This is explained in detail in conjunction with FIG. 8.

From the foregoing, it will appreciate that the above method and apparatus capable of managing and processing touch inputs from a user provides numerous benefits, such as improved way of accessing or editing UI elements in a touch based user interface without actually touching the UI elements. Further in a healthcare field, and particularly ultrasound imaging multiple measurement elements for performing measurements on an ultrasound image can be generated without actually providing touch inputs on the ultrasound image but by providing touch inputs regions around the actual region of interest in the image. So any gesture (touch gestures) provided anywhere in the UI around the area of interest results in drawing a measurement element in the area of interest. Moreover the user need not touch end points of the measurement elements drawn in the area of interest thus making them accurate. Hence end points of a measurement element are not covered. The user need not over stretch the finger for providing touch inputs while holding a handheld medical imaging apparatus thereby avoiding the problem user's finger not table to far locations in the UI. The user can use a left hand or a right hand for managing the UI elements in the user interface.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An apparatus capable of processing touch inputs from a user, the apparatus comprising:
a user interface configured as a touch sensitive display and capable of receiving touch inputs; and
a touch input processor configured to:
process touch inputs associated to a function in one or more first regions of the user interface; and
perform operations in a second region of the user interface to execute the function.

2. The apparatus of claim 1, wherein the function comprises performing measurement on a medical image, the medical image is presented in the user interface.

3. The apparatus of claim 2, wherein the touch inputs comprise gestures using user's finger.

4. The apparatus of claim 2, wherein the operations comprise generating one or more measurement elements, wherein the one or more measurement elements comprise a line, a circle, an ellipse and a shape.

5. The apparatus of claim 4, wherein the touch input processor is further configured to generate a measurement element of the one or more measurement elements by:
selecting a point at the second region in response to a gesture received as a touch input at a first region of the one or more first regions in the user interface; and
drawing a measurement element of the one or more measurement elements from the point based on at least one gesture received as the touch input from the user at the one or more first regions.

6. The apparatus of claim 5, wherein the measurement element is drawn in the second region based on a corresponding measurement element drawn in the one or more first regions.

7. The apparatus of claim 5, wherein the measurement element is drawn in the second region based on a gesture movement representing the measurement element received at the one or more first regions.

8. The apparatus of claim 2, wherein the touch input processor is further configured to set a measurement mode in response to at least one gesture performed at the one or more first regions of the user interface.

9. The apparatus of claim 4, wherein the touch input processor is further configured to relocate a measurement element of the one or more measurement elements based on one of at least one gesture and an input performed at the one or more first regions of the user interface.

10. The apparatus of claim 2, wherein the apparatus is a medical imaging apparatus.

11. A method of processing touch inputs from a user, the method comprising:
receiving touch inputs associated with a function at a user interface configured as a touch sensitive display;
processing the touch inputs received in one or more first regions of the user interface; and
performing operations in a second region of the user interface to execute the function.

12. The method of claim 11, wherein the function comprises performing measurement on a medical image, the medical image is presented in the user interface.

13. The method of claim 12, wherein the touch inputs comprise executing gestures using user's finger.

14. The method of claim 12, wherein the operations comprise generating one or more measurement elements, wherein the one or more measurement elements comprise a line, a circle, an ellipse and a shape.

15. The method of claim 14, wherein generating the one or more measurement elements comprises:
selecting a point at the second region in response to a gesture received as a touch input at a first region of the one or more first regions in the user interface; and
drawing a measurement element of the one or more measurement elements from the point based on at least one gesture received as touch input from the user at the one or more first regions.

16. The method of claim 15, wherein the measurement element is drawn in the second region based on one of:
a corresponding measurement element drawn in the one or more first regions; and
a gesture movement representing the measurement element received at the one or more first regions.

17. The method of claim 12 further comprises setting a measurement mode in response to at least one gesture performed at the one or more first regions of the user interface.

18. The method of claim 14 further comprises relocating a measurement element of the one or more measurement elements based on one of at least one gesture and an input performed at the one or more first regions of the user interface.
